(19) United States
(12) Patent Application Publication
(10) Pub. No.: US 2001/0030203 A1
(43) Pub. Date: Oct. 18, 2001

(54) Soap dispensing container

(76) Inventor: Heinz Weber, Beaconsfield (CA)

Correspondence Address: Eric Fincham, 316 Knowlton Road, Lac Brome, Quebec, J0E 1V0, CA

(21) Appl. No.: 09/733,134

(22) Filed: Dec. 8, 2000

Related U.S. Application Data
(60) Provisional application No. 60/169,820, filed on Dec. 8, 1999.

(51) Int. Cl. B67D 5/60

(52) U.S. Cl. 222/377; 222/464.7

(57) ABSTRACT

A container for dispensing a fluid such as soap wherein there is provided a main body portion having an internal cavity, a pump dispensing mechanism mounted to dispense a fluid from the internal cavity, the bottom wall of the main body being concave to define a centrally located sump with a distal end of a dipstick to be located proximate the sump, a support base being designed to engage and interlock with the main body side wall. The main body may be formed as an extrusion blow molded bottle.

The present application claims priority on U.S. Provisional application Serial No. 60/169,820 filed Dec. 8, 1999.

### FIELD OF THE INVENTION

The present invention relates to a container system and more particularly, relates to a container system having a pump associated therewith for dispensing a product from the container.

### BACKGROUND OF THE INVENTION

The use of pumps with containers is well known in the art and recently has achieved a fair degree of popularity for use with certain products. Primarily these products are different types of soaps packaged for use by the end consumer. Advantages of such containers and pumps include the fact that only the required amount of soap is dispensed and there is not a bar of soap which must be stored and which frequently is somewhat messy.

The containers used for the dispensing of soap like products must be produced in an economical fashion while at the same time, they must present an attractive package for the consumer as they frequently form a part of the decor either in the kitchen or bathroom.

One problem with the manufacture of such containers is that they tend to be arranged such that a portion of the liquid soap remains in the container and which portion is inaccessible due to the design of the container. A problem also is the cost of manufacture of the container—i.e. one cannot use an excess amount of material and one must also maintain certain aesthetics in the design of the container.

### SUMMARY OF THE INVENTION

It is an object of the present invention to provide a novel container system for the dispensing of a liquid product such as soap.

According to one aspect of the present invention, there is provided a container for dispensing a fluid, the container comprising a main body having a main body bottom wall, an interior cavity defined by the main body bottom wall, the main body side wall and the main body upper wall, a main body upper wall, an inlet aperture extending through the main body upper wall to the interior cavity, a pump dispensing mechanism mounted in the aperture in the main body upper wall, the pump dispensing mechanism having a dipstick tube extending downwardly into the cavity, the main body bottom wall being sloped downwardly to define a centrally located sump, a distal end of the dipstick tube being located proximate the sump, a support base, the support base having a support base bottom wall designed to sit on a planar substrate, and a support base side wall extending upwardly from the support base bottom wall, the support base side wall engaging and interlocking with the main body side wall.

Thus, according to the present invention, there is provided a container which may function in a conventional manner having a pump dispensing mechanism while there is also provided a support base which may blend with the main container body and which can also be aesthetically pleasing.

The main body and the support base may be made of any suitable material and preferably is formed of a plastic material. The materials used for the main body and the support base may be similar or dissimilar.

The pump dispensing mechanism may be any suitable and many such pump dispensing mechanisms are well known in the art.

### BRIEF DESCRIPTION OF THE DRAWINGS

Having thus generally described the invention, reference will be made to the accompanying drawings illustrating an embodiment thereof, in which:

FIG. 1 is a front elevational view of a container system according to the present invention;

FIG. 2 is an end elevational view of the container of FIG. 1 with the cap removed;

FIG. 3 is a detailed cross sectional view of the bottom portion of the container system;

FIG. 4 is a perspective view of the bottom portion of the container;

FIG. 5 is a side elevational view of a further embodiment of a container according to the present invention; and

FIG. 6 is a perspective view of the bottom portion thereof.

### DESCRIPTION OF THE PREFERRED EMBODIMENTS

Referring to the drawings in greater detail and by reference characters thereto, there is illustrated a container system generally designated by reference numeral 10 and which includes a container having a main body 12. Main body 12 is comprised of a pair of opposed side walls 14, 16 and opposed end walls 18, 20. The container includes a conventional neck 22 having external threads 24 thereon.

A cap 26 is designed to fit about neck 22 by screw threadedly engaging threads 24 in a conventional manner. Cap 26 includes a dispensing pump 28 which is of the conventional construction and is not illustrated in detail herein.

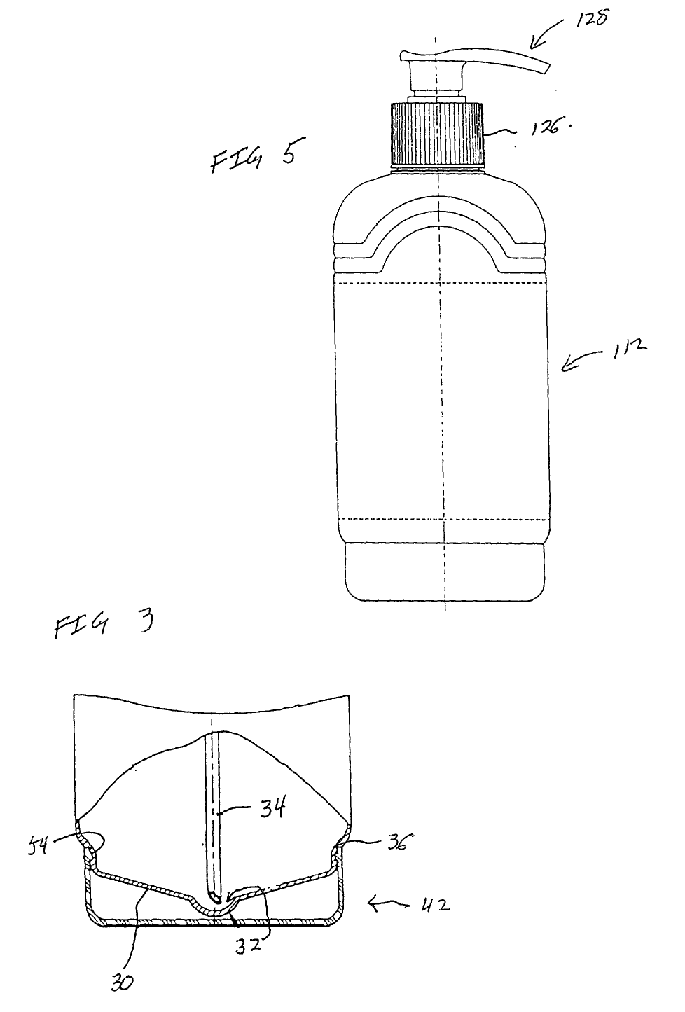

Body 12 includes a bottom wall 30 which, as may be seen in FIG. 3, has an overall concave inner surface with central recess 32 formed therein.

The arrangement of bottom wall 30 is such that dip stick tube 34 associated with dispensing pump 28 is able to reach substantially to the bottom of the container and thus ensure that all contents are dispensed with little or no waste.

However, since main body 12 is conventionally formed as an extrusion blow molded bottle, the formation of such a shape without means to stabilize the bottle is not possible.

However, according to the present invention, there is provided a support base 42 having a support base bottom wall 44, a pair of support base side walls 46, 48 and support base end walls, 50, 52. On each of side walls 46, 48 and end walls 50, 52 there is provided a protrusion 54 which is designed to engage with side wall recess 36 as shown in FIG. 3. Base 42 may be injection molded.

Thus, as will be seen from the above, there is provided an attractive container package wherein the contents may be fully accessed by the dip stick tube 34 while still providing an attractive package for use in the home.

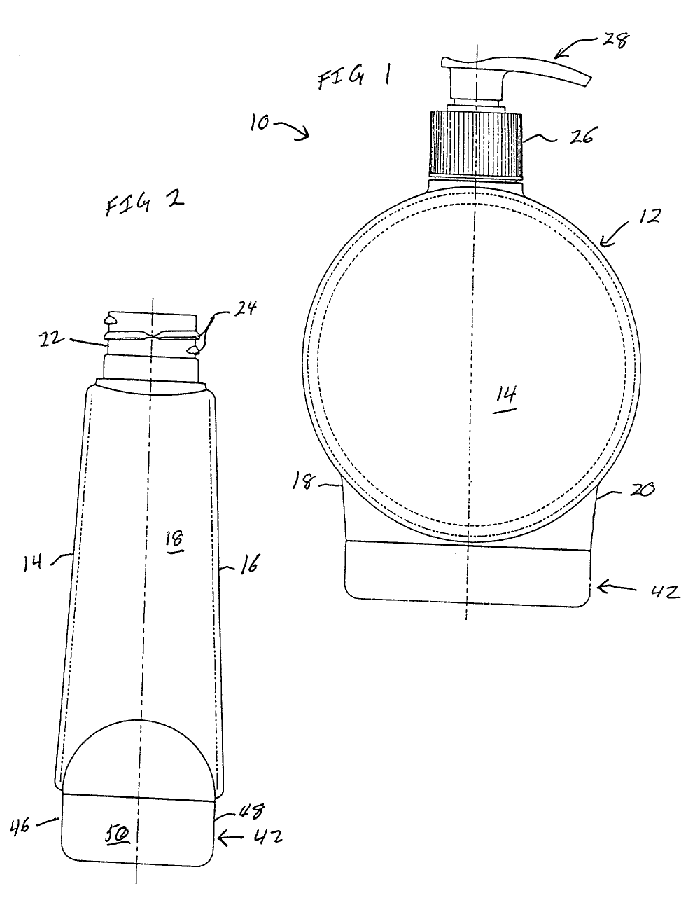

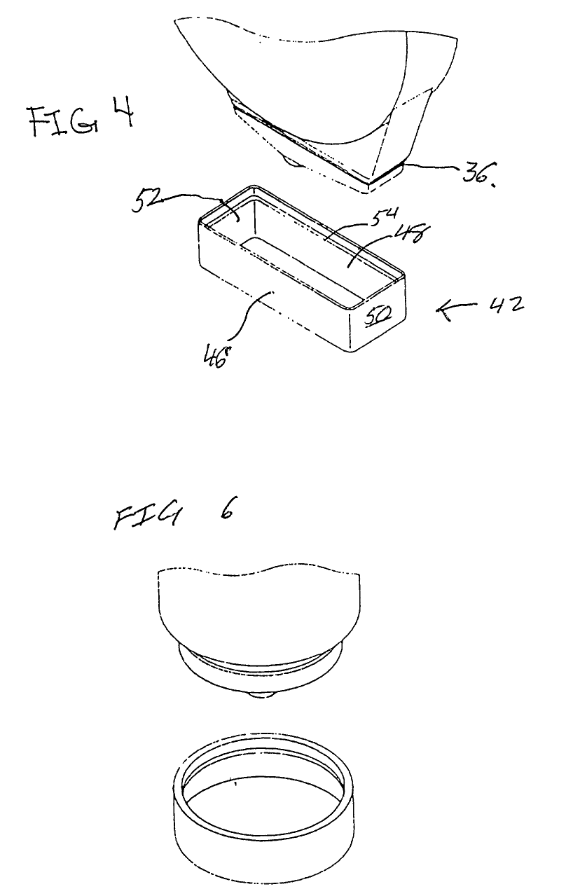

As shown in FIGS. 5 to 7, the container system may have different forms. Similar reference numerals are employed in the 100's for similar components. As may be seen, base 142 may be formed in a round style instead of the rectangular style shown in the embodiment of FIGS. 1 to 4.

It will be understood that the above described embodiments are for purposes of illustration only and that changes and modifications may be made thereto without departing from the spirit and scope of the invention.

I claim:

1. A container for dispensing a fluid, said container comprising:
a main body having a main body bottom wall, an interior cavity defined by said main body bottom wall, said main body side wall and said main body upper wall, a main body upper wall, an inlet aperture extending through said main body upper wall to said interior cavity, a pump dispensing mechanism mounted in said aperture in said main body upper wall, said pump dispensing mechanism having a dipstick tube extending downwardly into said cavity, said main body bottom wall being sloped downwardly to define a centrally located sump, a distal end of said dipstick tube being located proximate said sump;
a support base, said support base having a support base bottom wall designed to sit on a planar substrate, and a support base side wall extending upwardly from said support base bottom wall, said support base side wall engaging and interlocking with said main body side wall.

2. The container of claim 1 wherein said main body has a substantially rectangular configuration, said main body being defined by first and second opposed side walls and first and second opposed end walls.

3. The container of claim 1 wherein said container includes a mouth surrounding said main body upper wall aperture, said mouth having screw threads formed thereon to receive said pump dispensing mechanism.
